(19) United States
(12) Patent Application Publication
(10) Pub. No.: US 2021/0392942 A1
(43) Pub. Date: Dec. 23, 2021

(54) Method of Manufacturing a Meat Jerky Straw

(71) Applicant: Sammark Holdings , LLC, Glendale, WI (US)

(72) Inventor: Sam J. Maglio, JR., Mequon, WI (US)

(21) Appl. No.: 17/351,496

(22) Filed: Jun. 18, 2021

Related U.S. Application Data
(60) Provisional application No. 63/040,744, filed on Jun. 18, 2020.

(51) Int. Cl. A23P 30/25; A23B 4/027; A23B 4/30; A23B 4/03; A23B 4/10; A23L 13/60

(52) U.S. Cl. CPC A23P 30/25; A23B 4/027; A23B 4/305; A23V 2002/00; A23B 4/10; A23L 13/67; A23B 4/03

(57) ABSTRACT

An apparatus and method for making meat jerky in the form of a thin-walled tube uses a food extruder extruding a meat mixture through a tubular opening die and coating the meat mixture with a solution of calcium chloride to firm the meat mixture in the tubular form without collapsing. The present invention provides a reproducible process for creating meat jerky tubes with consistent length, width, and size portion.

### CROSS REFERENCE TO RELATED APPLICATION

This application claims the benefit of U.S. Provisional Application No. 63/040,744, filed Jun. 18, 2020, hereby incorporated by reference.

### BACKGROUND OF THE INVENTION

The present invention relates generally to an apparatus and method of making a tube of dried meat and, in particular, to a method of making meat or beef jerky in the form of a thin walled tube permitting the meat or beef jerky to be used inside a cup as a drinking straw.

Jerky products are lean trimmed meats that are typically cut into strips and dehydrated. The meats are dehydrated using a low temperature drying method with the addition of salt to prevent bacteria growth. Chemical preservatives such as sodium nitrite may be used with the salting process to help prevent bacterial growth in the meat.

Jerky is commonly made from domesticated animals such as beef, pork, goat and mutton or lamb and game animals such as deer, kudu, springbok, kangaroo, and bison. The process of making jerky typically requires fat to be removed since fat does not dry and increases the risk of spoilage. Then the meat must be dried quickly (the “critical period”) to limit the bacterial growth under low temperatures so that the meat does not cook. Large low temperature drying ovens or dehydrators with multiple heaters and fans are used to heat the meat placed on screens while removing the humidity in the air. Typically, to assist quick drying, the meat is sliced or pressed thin to increase the surface area of meat exposed to the air.

The preparation and dehydration process used to make jerky normally requires the removal of fat, the addition of salt and chemical preservatives, and quick drying under low temperatures. The process depends on the preparation of the meat to prevent bacterial growth and thin, flat slices to facilitate drying.

### SUMMARY OF THE INVENTION

The present invention provides a beef jerky making system which produces the beef jerky in thin walled hollow tubes that may be used as drinking straws. The process is more difficult than producing thin, flat slices of jerky since the meat must be extruded into a tube form with low fat content, making it more difficult to keep the meat together and maintain the tube form without collapsing, and then dried quickly (to limit bacterial growth) despite its three-dimensional geometry.

The present invention provides a method of making a tube of dried meat including forming a meat composition comprising ground meat and sodium alginate; passing the meat composition along an axis through a die having a ring-shaped opening with an outer diameter concentric about the axis and an inner diameter concentric about the axis with the meat composition forced out between the inner and outer diameter to form a tube of extruded meat; coating at last one of an inner and outer surface of the tube of extruded meat with a solution of calcium chloride; and drying the extruded tube of meat to remove moisture from the extruded tube.

It is thus a feature of at least one embodiment of the present invention to provide a thin walled meat extrusion process for producing beef jerky tubes to be used as drinking straws without collapsing of the tubes prior to the drying or dehydration process.

The solution of calcium chloride may be 0.5 to 1.5 wt % calcium chloride. The meat composition may be 0.5 to 1.5 wt % sodium alginate.

It is thus a feature of at least one embodiment of the present invention to provide firming of the extruded meat tube prior to slicing and drying or dehydration to form a firm tube that has structural integrity.

The meat composition may be 85 to 95 wt % ground meat. The meat composition may further include an additive comprising at least one of seasoning mixture, sodium nitrite and curing salt.

It is thus a feature of at least one embodiment of the present invention to provide meat mixtures that allow for the production of meat or beef jerky with the expected jerky look and flavor.

The method may further include the step of spraying the inner and outer surface of the extruded tube of meat with the solution of calcium chloride.

It is thus a feature of at least one embodiment of the present invention to coat both walls of the extruded tube of meat to firm the structure of the tube and prevent collapsing of the tube when slicing into smaller tube lengths.

The method may further include the step of dripping the solution of calcium chloride onto the extruded tube of meat.

It is thus a feature of at least one embodiment of the present invention to coat the meat mixture with the firming solution without placing high sprayer forces on the soft meat mixture.

The extruded tube of meat may be further cut into predetermined tube segments.

It is thus a feature of at least one embodiment of the present invention to provide an easy to package and consumable food product.

The extruded tube of meat may be coated with calcium chloride for at least 10 seconds prior to being cut into predetermined tube segments.

It is thus a feature of at least one embodiment of the present invention to allow time for the calcium chloride solution to react with the meat mixture in order for the meat mixture to firm prior to slicing.

The predetermined tube segments may be between 6 and 10 inches in length.

It is thus a feature of at least one embodiment of the present invention to provide a standard length commensurate with a drinking straw.

The predetermined tube lengths may include approximately 1 to 2 oz. of extruded meat mixture.

It is thus a feature of at least one embodiment of the present invention to provide a consumable food product that may be eaten following use as a drinking straw.

The extruded tube of meat may be dried for 2 to 8 hours at a temperature of at least 150 degrees Fahrenheit. The extruded tube may have a moisture to protein ratio of 0.75:1 or lower.

It is thus a feature of at least one embodiment of the present invention to provide a dried meat that may be firm and dried enough to withstand liquid contact such as would be encountered when placed within a drink during drinking straw use.

The present invention also provides a method of making a tube of dried meat including providing an assembly for making a tube of dried meat having a hopper receiving a meat mixture comprising ground meat and sodium alginate; an extruder passing the meat mixture from the hopper through a barrel translating the meat mixture along the barrel; a die having a ring shaped opening and permitting the meat mixture to be fed through the die to produce a tube of extruded meat having an inner surface and an outer surface; and a blade slicing the tube of extruded meat into predetermined tube lengths. The method further includes loading the meat mixture into the hopper; extruding the meat mixture through the die; coating the inner surface and outer surface of the tube of extruded meat with a solution of calcium chloride; slicing the tube of extruded meat into predetermined tube lengths; and drying the predetermined tube lengths to a moisture to protein ratio of 0.75:1 or lower.

It is thus a feature of at least one embodiment of the present invention to provide an apparatus for producing extruded meat tubes that allow for rapid firming of the extruded meat tubes.

The assembly may further comprise a conveyor belt receiving the tube of extruded meat from the die.

It is thus a feature of at least one embodiment of the present invention to allow additional time for the meat tubes to firm during the automated assembly process of extrusion and portioning/cutting.

The assembly further comprises a trough holding the solution of calcium chloride and dripping the solution of calcium chloride onto the tube of extruded meat from the die. The trough may be held above the conveyor belt to drip the solution of calcium chloride onto the conveyor belt.

It is thus a feature of at least one embodiment of the present invention to gently coat the meat mixture with a firming solution without damaging the structure of the meat tube.

The assembly may further comprise an inner spray tube and outer spray tube coating the inner surface and the outer surface, respectively, of the tube of extruded meat.

It is thus a feature of at least one embodiment of the present invention to coat the inside and outside of the meat tube for firming both surfaces of the tube structure.

These particular objects and advantages may apply to only some embodiments falling within the claims and thus do not define the scope of the invention.

### BRIEF DESCRIPTION OF THE DRAWINGS

FIG. 1 is a perspective view of the vacuum filler machine of the present invention as used for the extrusion of a meat mixture in the form of thin walled hollow tubes to a portioning/cutting assembly;

FIG. 2 is an enlarged front planar view of the portioning assembly of FIG. 1 showing the tubular opening die and spray tube apparatus for coating the meat mixture tubes with calcium chloride solution;

FIG. 3 is a simplified side cross sectional view of the portioning/cutting assembly showing the tubular opening die and cutting blade;

FIG. 4 is a flow chart showing the steps for the process of beef jerky making according to the present invention;

FIG. 5 is a simplified schematic top elevation view of an alternative embodiment of the present invention showing the vacuum filler machine being used to extrude meat mixture tubes to a conveyor belt and portioning/cutting assembly; and

FIG. 6 is a simplified schematic side cross sectional view of the alternative embodiment of the present invention of FIG. 5 showing a trough held above the conveyor belt dripping calcium chloride solution onto the extruded meat mixture tubes on the conveyor belt prior to portioning/cutting.

### DETAILED DESCRIPTION OF THE PREFERRED EMBODIMENT

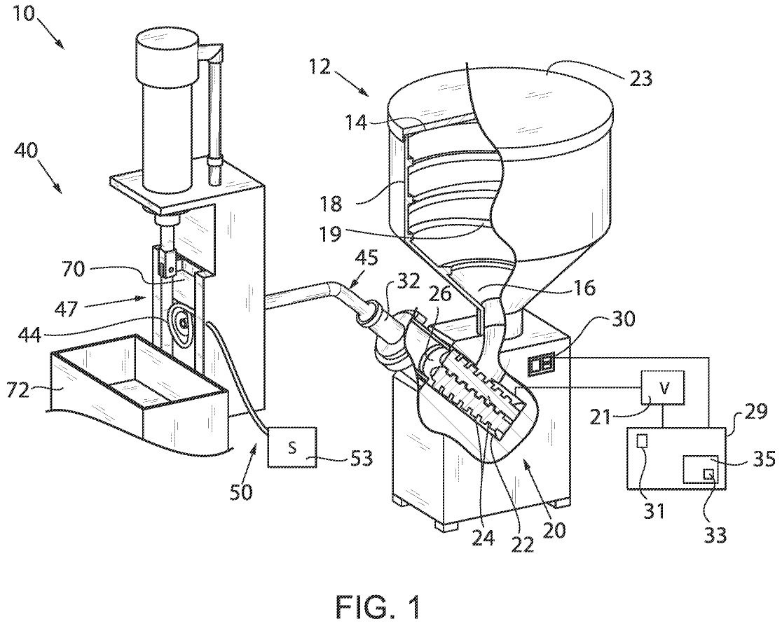

Referring to FIG. 1, a method of making beef jerky of the present invention may utilize a vacuum filler machine 10 used to dispense reproducible length, width, and size portions of soft mixtures such as soft meat mixtures. For example, the vacuum filler machine 10 may be a food extruder and may be commercially sold under the trade name “ROBOT500” manufactured by Vemag of Verden, Germany.

A hopper 12 of the vacuum filler machine 10 may comprise of a funnel 18 that is wide on a top end 14 and narrow on a bottom end 16 and that receives the meat mixture 28 poured through the open top end 14 and is compressed within the hopper 12 by a spiral feed screw 19 which rotates along an inner wall of the funnel 18 to feed the meat mixture 28 downwards toward the bottom end 16 of the funnel 18 to then further enter an extruder, for example, a single or twin-screw system 20 (a twin-screw system is shown in FIG. 1) positioned below the hopper 12, and with the aid of a vacuum system 21 which helps to “suck” the meat mixture 28 downwards. A scraper (not shown) which is swiped along the inner surface of the funnel 18 may be used to ensure that the meat mixture 28 is substantially emptied from the hopper 12 into the twin-screw system 20.

The spiral feed screw 19 and/or the twin-screw system 20 may turn off automatically if a cover 23 over the top end 14 of the hopper 12 is not closed thereover to prevent accidental injury which may be caused by accidentally contacting the spiral feed screw 19 and/or the twin-screw system 20 while in operation.

The twin-screw system 20 may include a cylindrical barrel 22 holding a pair of parallel threaded screws 24 that extend at an upward angle from a position below the hopper 12 to an outlet 26 of the cylindrical barrel 22. The threads of the threaded screws 24 may receive the meat mixture 28 from the hopper 12 and then convey the meat mixture 28 gently and evenly along the twin-screw system 20 in an upward direction to the outlet 26. Air may be withdrawn from the meat mixture 28 through the vacuum system 21 associated with the twin-screw system 20. It is understood that the twin-screw system 20 may alternatively be a single screw system including a single threaded screw, as understood in the art, or other types of extruders known in the art.

In order to control the consistent size portions of meat mixture 28 delivery, the twin-screw system 20 provides that the same volume of meat mixture 28 is dispensed with each rotation of the threaded screws 24. Therefore, the speed of the screws 24 may be adjusted to change the quantity of the product dispensed, for example, through a graphic display and user input interface 30. The user may be able to turn the vacuum filler machine 10 on and off, turn the vacuum system 21 on and off, control the vacuum system 21 to increase or decrease the vacuum, control the speed of rotation of the threaded screws 24, and the like, through the user input interface 30.

The vacuum system 21 and the twin-screw system 20 may be controlled by a controller 29 including a processor 31 executing a stored program 33 in computer memory 35 communicating with the graphic display and user input interface 30 to control the various components as described or may be implemented as discrete circuitry according to techniques well known in the art. For example, the controller 29 may control a motor of the twin-screw system 20 driving rotation of the threaded screws 24 of the twin-screw system 20 and may also control power to the vacuum system 21 to control a power level of the vacuum.

The meat mixture 28, which will be described in further detail below, may be continuously dispensed by the twin-screw system 20 or in individual portions with the number of screw rotations relating to a measure of the weight and/or volume of an individual portion. The twin-screw system 20 may be fed until the meat mixture 28 is fully dispensed from the threaded screws 24. It is understood that an individual portion of meat mixture 28 from the twin-screw system 20 may be further cut to provide multiple meat tubes by a portioning assembly 40 as further described below.

The vacuum filler machine 10 used in connection with the present invention may be as described in U.S. Pat. No. 6,132,302, filed Oct. 8, 1998, entitled “Device for filling casings as well as machine for filling sausage casings”; U.S. Pat. No. 8,757,865, filed Sep. 19, 2013, entitled “Foodstuff conveyor apparatus and method of conveying a foodstuff”; and U.S. Publication 2010/0199862, filed Dec. 18, 2009, entitled “Apparatus for Filling and/or Treatment of Paste-Like Masses, In Particular Sausage Meat,” each of which is hereby incorporated by reference.

Although the present invention is being described with respect to use of a vacuum filler machine 10 as manufactured by Vemag, other vacuum filler machines and food extruders may be used in connection with the present invention, for example, multi co-extruders manufactured by Rheon Automatic Machinery Co. of Japan and the like, and in a similar manner.

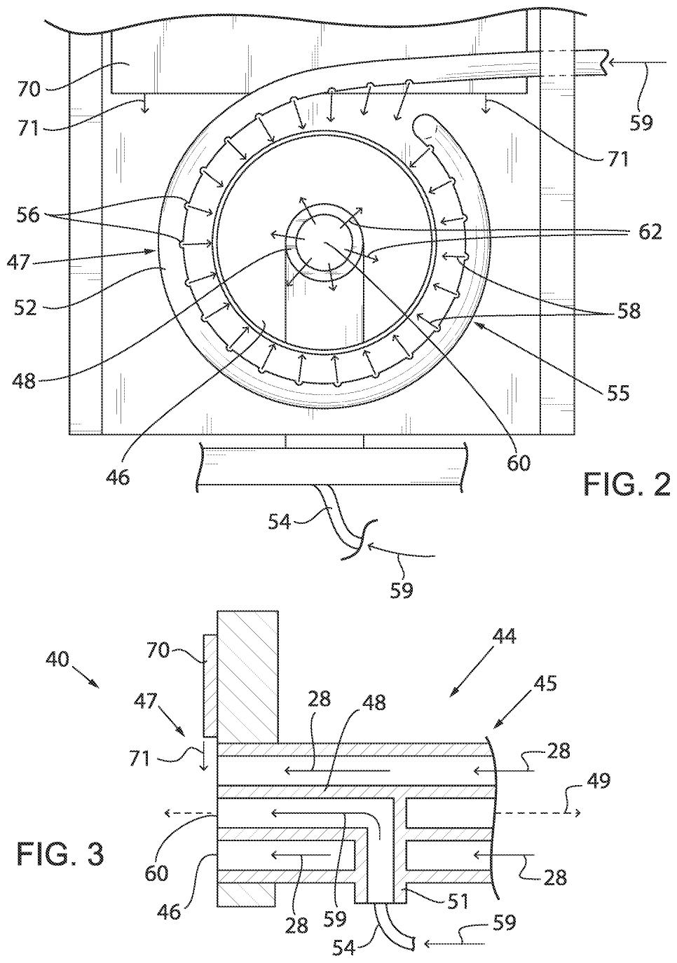

Referring now also to FIGS. 2 and 3, at the extruder head or outlet 26 of the twin-screw system 20 may be a tubular sleeve or connection tube 32 that may be curved or bent to transfer the meat mixture 28 away from the twin-screw system 20 to the portioning assembly 40. The meat mixture 28 may be ejected by the rotational forces of the twin-screw system 20 to travel through the connection tube 32. The meat mixture 28 may be fed from the sleeve or connection tube 32 to a tubular opening die 44 to create the meat mixture 28 in a tubular shape. The tubular opening die 44 may extend from an inlet side 45 receiving the meat mixture 28 to an outlet side 47 dispensing a tube 37 of extruded meat mixture 28 from the tubular opening die 44.

The tubular opening die 44 may include a circular orifice 46 with an outer diameter between 13-16 mm and between 15-16 mm and approximately 15.9 mm. The center of the tubular opening die 44 includes a hollow mandrel 48 that creates the internal passageway of the tube, with an outer diameter between 5-10 mm and between 7-9 mm and approximately 8 mm, and an inner diameter between 3-9 mm and between 4-8 mm and approximately 5 mm. The mandrel 48 may extend along a central axis 49 of the circular orifice 46 of the tubular opening die 44 and may be supported at the center of the circular orifice 46 by a tube portion 51 extending from the mandrel 48 along an axis perpendicular to the central axis 49. The meat mixture 28 is pushed through the circular orifice 46 and surrounds the outside of the hollow mandrel 48 in order to extrude a tubular structure 37 of meat mixture 28 having a wall thickness between 3-5 mm and approximately 4 mm. It is understood that structural (porthole), as described above, and seamless die extrusion methods, as known in the art, may be used to similarly extrude the tubular structure of meat mixture 28.

As best seen in FIG. 3, the tubular opening die 44 may be fitted with a spray apparatus 50 proximate the outlet side 47 of the tubular opening die 44 that sprays an inner and outer surface of the tubular structure 37 of meat mixture 28 with a meat firming solution. The spray apparatus 50 may include an outer tubing 52 that is suspended in a loop 55 around the outer diameter of the of the circular orifice 46. The diameter of the loop 55 formed by the outer tubing 52 may have a diameter that is greater than the outer diameter of the circular orifice 466 and may be between 18-25 mm in diameter extending around the circular orifice 46. An inner tubing 54 is directed into the tube portion 51 to emit fluid into a hollow interior of tube portion 51 and the hollow mandrel 48. The outer tubing 52 and inner tubing 54 may receive a pressurized meat firming solution, for example, calcium chloride solution 59 from a solution source 53 to spray the calcium chloride solution 59, for example, a solution of calcium chloride dissolved in water as further described below.

The outer tubing 52 may include a plurality of small outlet holes 56 spaced apart and extending along an inner circumference of the loop 55 formed by the outer tubing 52 such that the spray of pressurized calcium chloride solution 59 is directed inwardly in radial directions 58 onto an outer surface of the extruded tube 37 of meat mixture 28. The plurality of small outlet holes 56 may have a diameter of approximately 0.5-1 mm.

The inner tubing 54 may emit a spray of water through the tube portion 51 and hollow mandrel 48 to an open end 60 of the hollow mandrel 48 such that the spray of pressurized calcium chloride solution 59 is directed outwardly in radial directions 62 and in a forward direction along axis 49 onto an inner surface of the extruded tube 37 of meat mixture 28 before it is cut as further described below.

Therefore, the spray apparatus 50 is able to emit a spray of calcium chloride solution 59 onto the inner surface and outer surface of the extruded tube 37 of meat mixture 28. The pressure of the pressurized calcium chloride solution 59 as it exits the small outlet holes 56 and the open end 60 of the hollow mandrel 48 may be between 5-60 psi and between 15-20 psi and approximately 18 psi. The outer tubing 52 and inner tubing 54 may be made from vinyl, rubber, polyurethane, and the like, in order to withstand the pressure forces of the spray.

The portioning assembly 40 may include a knife or blade 70 that is programmed to cut the continuously extruded tube 37 of meat mixture 28 at predetermined time intervals to produce desired lengths of tubular structures 39. For example, the knife or blade 70 may be a shutter-type or a guillotine-type cutter that is able to cut 30-50 cuts per minute or approximately 40 cuts per minute. In some embodiments, the portioning assembly 40 may include multiple knives or blades 70. The knife or blade 70 may be translated in a downward direction 71 at the outlet side 47 of the tubular opening die 44 to cut the extruded tube 37 of meat mixture 28 into the desired lengths. In one embodiment, the knife or blade 70 may be positioned between the tubing die 44 and the outer tubing 52. The outer tubing may direct calcium chloride solution 59 onto the extruded tubular meat mixture before and/or simultaneous with the extruded tube 37 of meat mixture 28 being cut by the knife or blade 70.

After slicing, the sliced tubes 39 of meat mixture 28 may drop down into and be held within a collection bin 72 or collection tray 73 held below the blade 70 prior to the dehydrating steps described below.

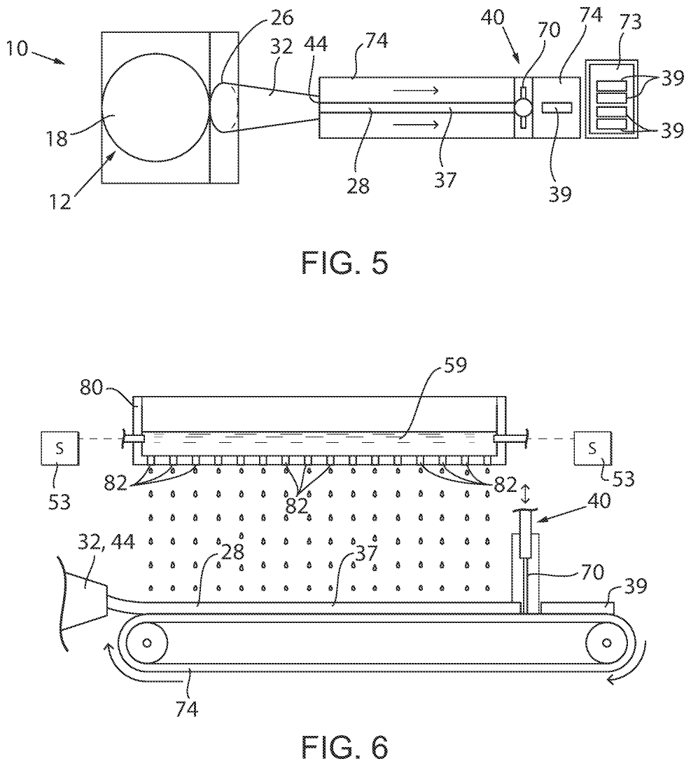

Referring briefly to FIG. 5, in an alternative embodiment, the portioning assembly 40 may be separated from the tubular opening die 44 by a conveyor belt 74. The extruded tube 37 of meat mixture 28 may drop onto the conveyor belt 74 generally moving at a speed consistent with the speed of extrusion. In this alternative embodiment, the extruded tubes 37 of meat mixture 28 may be sliced by the knife or blade 70 after being translated along the conveyor belt 74, however, it is contemplated that the extruded tube 37 of meat mixture 28 may also be cut before being conveyed along the conveyor belt 74 which carries the sliced tubes 39 to the collection bin 72 or collection tray 73.

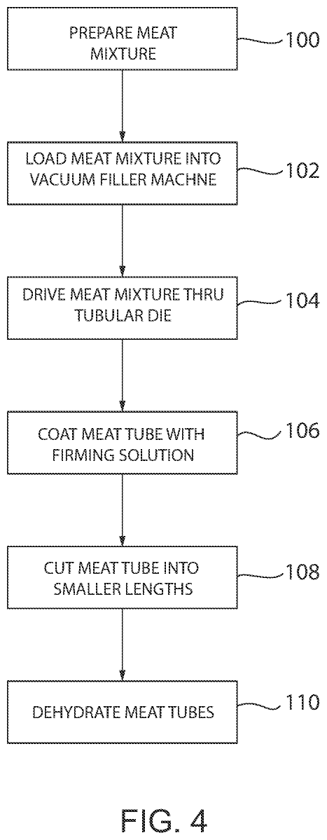

Referring now to FIG. 4, as illustrated by step 100, the meat mixture 28 may be prepared using a combination of lean ground beef, seasoning mixture, sodium nitrite, sodium alginate, curing salt (optional), and water (optional). The sodium nitrite is a salt additive and anti-oxidant that is used to add the color and flavor of dehydrated meats. The sodium alginate is a salt additive that is used to preserve foods and inhibit the growth of bacterial spores. The optional curing salt is a high sodium product used to add flavor.

The meat mixture may contain between 85-95 wt % lean ground beef and at least 85 wt % and at least 90 wt % and approximately 87 wt % lean ground beef and approximately 93 wt %; between 1-5 wt % seasoning and sodium nitrite mixture and at least 3 wt % and at least 3.5 wt % and approximately 3 wt % seasoning and sodium nitrite mixture; between 0-10 wt % water and at least 3 wt % and at least 5 wt % and approximately 3 wt % and approximately 5 wt % water; between 0.5-1.5 wt % sodium alginate and at least 0.5 wt % and approximately 1 wt % sodium alginate; between 0-3 wt % curing salt and at least 2 wt % and approximately 2 wt % curing salt.

As illustrated by step 102, the meat mixture 28 may be loaded into the hopper 12 of the vacuum filler machine 10 as shown in FIG. 1. The vacuum system 21 may pull the meat mixture 28 into the twin-screw system 20. The twin-screw system 20 may drive the meat mixture 28 through the connection tube 32 and through the tubular opening die 44 to the portioning assembly 40. In one embodiment, the settings of the vacuum filler machine 10 may be as follows: Weight=0200 (i.e., how long the twin-screws should turn to pump out the entire quantity of mean mixture), HT−N/A (i.e., adjustment for links), Pause=220 (i.e., milliseconds of stop time on screws while blade cuts tube), Twist=100 (i.e., firing time of blade to cut tube in milliseconds), Speed=35 (i.e., percent of maximum screw speed).

As illustrated by step 104, at the portioning assembly 40, the meat mixture 28 is extruded through the tubular opening die 44 to produce the extruded tube 37 of meat mixture 28. The extruded tube 37 of meat mixture 28 may have an outer diameter that is between 13-16 mm and approximately 15 mm, and an inner diameter that is between 5-7 mm and approximately 6 mm.

As illustrated by step 106, after the meat mixture 28 is extruded, the spray apparatus 50 may wet the inside and outside (inner surface and outer surface) of the extruded tube 37 of meat mixture 28 with the calcium chloride solution 59 which may be held within a solution source 53, e.g., a container or basin holding the solution.

The calcium chloride solution 59 loaded into the solution source 53 may be between 0.5-1.5 wt % calcium chloride and approximately 1 wt % calcium chloride and between 98-99 wt % water and approximately 99 wt % water. The interaction between the sodium alginate of the meat mixture 28 and calcium chloride of the calcium chloride solution 59, by coating the inside and outside of the extruded tube 37, causes the sodium alginate to crosslink and a setting action to take place within the meat mixture 28 to prevent the extruded tube 37 from collapsing.

As illustrated by step 108, the extruded tube 37 of meat mixture 28 is cut or sliced by the knife or blade 70 into desired lengths and are further collected by the collection bin 72. In one embodiment of the present invention, the desired length of the sliced tubes 39 of meat mixture 28 may be between 6-10 inches and between 7-9 inches and approximately 8 inches and approximately 8 and ⅜ inches. The sliced tubes 39 of meat mixture 28 may include between 1-2 oz. and approximately 1.2 oz. (34 g) of meat mixture 28.

Referring to FIG. 5, in an alternative embodiment of the invention, the extruded tube 37 of meat mixture 28 may be coated on the inside and outside of the extruded tube 37 with the calcium chloride solution 59 as described with respect to step 106, and then dropped onto a moving conveyor belt 74 which gives the extruded tube 37 of meat mixture 28 additional time to firm prior to cutting. The extruded tube 37 of meat mixture 28 may travel for 10 to 20 seconds and at least 10 seconds and at least 15 second along the moving conveyor belt 74 prior to cutting. The moving conveyor belt 74 may be approximately 6-12 inches wide and 6-10 feet long with an AC inverter speed controller controlling the speed of the moving conveyor belt 74.

Referring to FIG. 6, in addition to or replacing the spray apparatus 50, a trough 80 being substantially the same width and length of the moving conveyor belt 74 may provide a container holding additional calcium chloride solution 59 positioned above the moving conveyor belt 74. The trough 80 may receive calcium chloride solution 59 which is pumped from the solution source 53 and re-circulated back to the solution source 53. Small holes 82 in the floor of the trough 80 may allow calcium chloride solution 59 to drip down onto the extruded tube 37 of meat mixture 28 as it travels along the moving conveyor belt 74 in order to gently coat the outside of the extruded tube 37 of meat mixture 28 with the calcium chloride solution 59. The small holes 82 may extend along the length of the trough 80 and toward the center of the width of the trough 80 to fall onto the extruded meat mixture 28 which is generally centered along the width of the conveyor belt 74. The moving conveyor belt 74 may include openings allowing the calcium chloride solution 59 to drain from the conveyor belt 74 and into a collection container or drain (not shown).

In an alternative embodiment of the invention, the spraying process of step 106 completed by the spray apparatus 50 may be replaced by a submersion process in which the extruded tube 37 of meat mixture 28 is submerged in the calcium chloride solution 59 before the extruded tube 37 of meat mixture 28 is cut by the automated knife or blade 70 in step 108. For example, the extruded tube 37 of meat mixture 28 may be dropped into a trough of a moving conveyor belt holding calcium chloride solution 59 and immerged in calcium chloride solution 59 within the trough.

In this respect, it is understood that alternative methods of coating the inside and outside of the extruded tube 37 with the calcium chloride solution 59 prior to cutting the extruded tube 37 are contemplated by the present invention.

Referring again to FIG. 5, at or towards the end of the moving conveyor belt 74, opposite the tubular opening die 44 and spray apparatus 50, may be a knife or blade 70 as described above with respect to step 108, which may cut the extruded tube 37 of meat mixture 28 into desired lengths once the meat mixture 28 is more fully firmed along the conveyor belt 74. The sliced tubes 39 of extruded meat mixture 28 may drop into the collection bin 72 after being sliced or may travel further along the moving conveyor belt 74 to be dropped into the collection bin 72 or directly onto a collection tray 73 to be further loaded into the dryer or dehydrator.

As illustrated in step 110, the sliced tubes 39 of extruded meat mixture 28 are recovered from the collection bin 72 and then placed on a collection tray 73 for transfer to a dryer or dehydrator for baking. In some embodiments, the sliced tubes 39 of extruded meat mixture 28 may be dropped directly onto the collection tray 73 instead of dropped into the intermediate collection bin 72.

The dryer or dehydrator may be a heated cabinet operating at a temperature of at least 150 degrees Fahrenheit and approximately 160 degrees Fahrenheit, and the tubes of extruded meat mixture 28 are heated for approximately 2-8 hours while heat is circulated therein the dryer or dehydrator.

As the sliced tubes 39 of extruded meat mixture 28 are dried, the meat shrinks, opening the cut ends of the sliced tubes 39. Approximately 0.6 oz. (17 g) of water is removed from the tubes 39 of extruded meat mixture 28 during the dehydration or drying process to leave approximately 0.6 oz. (17 g) of dried meat. The moisture to protein ratio of the dried meat is 0.75:1 or lower. Following the drying process, the tubes 39 may be placed within a freezer for cooling and storage.

The final product is a firm and edible tube of meat jerky. The meat jerky may be packaged in plastic bags that are nitrogen gas flushed or vacuum packed for future consumption. The meat jerky may also be sealed with oxygen absorber to prevent the oxidation of fat.

The following examples are offered for illustrative purposes only and are not intended to limit the scope of the present invention in any way. Various modifications of the invention in addition to those shown and described herein will become apparent to those skilled in the art from the foregoing description and the following examples and fall within the scope of the appended claims.

### EXAMPLE 1

### Preparation of Meat Mixture

In one embodiment of the present invention, the meat mixture 28 includes the following ingredients and approximate amounts of those ingredients.
9000 g—80 wt % lean/20 wt % fat ground beef
320 g—seasoning and sodium nitrite mixture
50 g—sodium alginate
300 g water (optional)

The meat mixture may be prepared by adding the seasoning mixture and sodium alginate to water to form a paste. The ground beef may be placed into an 80-quart mixer and the paste may be added to the ground beef.

The resulting meat mixture may be allowed to rest for 30 minutes at approximately 38 degrees Fahrenheit.

### EXAMPLE 2

### Preparation of Meat Mixture

In one embodiment of the present invention, the meat mixture 28 includes the following ingredients and approximate amounts of those ingredients.
13800 g—80 wt % lean/20 wt % fat ground beef
600 g—seasoning mixture
350 g—curing salt
150 g—sodium alginate
900 g—water

The meat mixture may be prepared by mixing the dry ingredients (seasoning mixture, curing salt, sodium alginate) in a bowl. The water is placed into a medium mixer bowl (20 quart) and the dry ingredients slowly added to make a paste by whisking the mixture at medium speed. The ground beef and paste are placed in a large mixer bowl (60 quart). The mixture is mixed for 30 seconds on low speed then mixed for two minutes on medium speed.

The mixture is spread out on a pan and placed in the refrigerator for 60 minutes, cooling the mixture to 45 degrees Fahrenheit.

### EXAMPLE 3

### Preparation of Firming Solution

In one embodiment of the present invention, the calcium chloride solution 59 includes the following ingredients and approximate amounts of those ingredients:
17,000 g of water
200 g calcium chloride

### EXAMPLE 4

### Preparation of Firming Solution

In one embodiment of the present invention, the calcium chloride solution 59 includes the following ingredients and approximate amounts of those ingredients:
20,000 g of water
200 g calcium chloride

Certain terminology is used herein for purposes of reference only, and thus is not intended to be limiting. For example, terms such as “upper,” “lower,” “above,” and “below,” refer to directions in the drawings to which reference is made. Terms such as “front,” “back,” “rear,” “bottom,” and “side,” describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first,” “second,” and other such numerical terms referring to structures do not imply a sequence or order unless clearly indicated by the context. Although the stator and rotors are shown as disks in the disclosed embodiments, there is no requirement that the stator or rotor be in a disk form.

When introducing elements or features of the present disclosure and the exemplary embodiments, the articles “a,” “an,” “the,” and “said,” are intended to mean that there are one or more of such elements or features. The terms “comprising”, “including,” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

References to “a microprocessor” and “a processor” or “the microprocessor” and “the processor,” can be understood to include one or more microprocessors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

What I claim is:

1. A method of making a tube of dried meat comprising:
forming a meat composition comprising ground meat and sodium alginate;
passing the meat composition along an axis through a die having a ring-shaped opening with an outer diameter concentric about the axis and an inner diameter concentric about the axis with the meat composition forced out between the inner and outer diameter to form a tube of extruded meat;
coating at least one of an inner and outer surface of the tube of extruded meat with a solution of calcium chloride; and
drying the tube of extruded meat to remove moisture from the extruded tube.

2. The method of claim 1 wherein the solution of calcium chloride is 0.5 to 1.5 wt % calcium chloride.

3. The method of claim 1 wherein the meat composition is 0.5 to 1.5 wt % sodium alginate.

4. The method of claim 3 wherein the meat composition is 85 to 95 wt % ground meat.

5. The method of claim 4 wherein the meat composition further comprises an additive comprising at least one of a seasoning mixture, sodium nitrite and curing salt.

6. The method of claim 1 further comprising the step of spraying the inner and outer surface of the extruded tube of meat with the solution of calcium chloride.

7. The method of claim 1 further comprising the step of dripping the solution of calcium chloride onto the extruded tube of meat.

8. The method of claim 1 wherein the extruded tube of meat is coated with calcium chloride for at least 10 seconds prior to being cut into predetermined tube segments.

9. The method of claim 1 wherein the extruded tube of meat is further cut into predetermined lengths of tube segments.

10. The method of claim 9 wherein the tube segments are between 6 and 10 inches in length.

11. The method of claim 10 wherein the tube segments include approximately 1 oz. to 2 oz. of meat mixture.

12. The method of claim 1 wherein the extruded tube of meat is dried for 2 to 8 hours at a temperature of at least 150 degrees Fahrenheit.

13. The method of claim 1 wherein the extruded tube of meat after drying has a moisture to protein ratio of 0.75:1 or lower.

14. A method of making a tube of dried meat comprising:
providing an assembly for making a tube of dried meat comprising
a hopper receiving a meat mixture;
an extruder passing the meat mixture from the hopper through a barrel translating the meat mixture along the barrel;
a die having a ring shaped opening and permitting the meat mixture to be fed through the die to produce a tube of extruded meat having an inner surface and an outer surface; and
a blade slicing the tube of extruded meat into predetermined tube lengths;
loading the meat mixture comprising ground meat and sodium alginate into the hopper;
extruding the meat mixture through the die;
coating the inner surface and outer surface of the tube of extruded meat with a solution of calcium chloride;
slicing the tube of extruded meat into predetermined tube lengths; and
drying the predetermined tube lengths to a moisture to protein ratio of 0.75:1 or lower.

15. The method of claim 14 wherein the assembly further comprises a conveyor belt receiving the tube of extruded meat from the die.

16. The method of claim 15 wherein the assembly further comprises a trough holding the solution of calcium chloride and dripping the solution of calcium chloride onto the tube of extruded meat.

17. The method of claim 16 wherein the trough is held above the conveyor belt to drip the solution of calcium chloride onto the tube of extruded meat held by the conveyor belt.

18. The method of claim 14 wherein the assembly further comprises an inner spray tube and outer spray tube coating the inner surface and the outer surface, respectively, of the tube of extruded meat.
